(19) United States
(12) Patent Application Publication
(10) Pub. No.: US 2026/0084590 A1
(43) Pub. Date: Mar. 26, 2026

(54) SEAT, IN PARTICULAR A VEHICLE SEAT

(71) Applicant: Adient US LLC, Plymouth, MI (US)

(72) Inventors: Bernard GILMORE, Burscheid (DE); Thomas DILLINGER, Ratingen (DE)

(21) Appl. No.: 19/111,352

(22) PCT Filed: Aug. 31, 2023
(86) PCT No.: PCT/IB2023/058610

§ 371 Date: Mar. 13, 2025

(30) Foreign Application Priority Data
Sep. 15, 2022 (DE) 10 2022 209 684.2
May 11, 2023 (DE) 10 2023 204 366.1

(51) Int. Cl. B60N 2/18; B60N 2/02; B60N 2/22

(52) U.S. Cl. CPC B60N 2/1842; B60N 2/02246; B60N 2/22

(57) ABSTRACT

A vehicle seat may have at least one seat structure and an adjustment device with at least one pivot mechanism for pivoting the seat structure about a pivot axis. The seat structure may have at least one seat frame and a seat shell that is pivotally mounted on the seat frame. The pivot mechanism may be coupled to the seat structure and may be designed to move the seat frame about the pivot axis and, depending on a pivot direction of the seat frame, to move the seat shell relative to same and in a pivot direction opposite the pivot direction of the seat frame.

The invention relates to a seat, in particular a vehicle seat.

### PRIOR ART

Adjustable vehicle seats, for example reclining seats, which are actuatable in such a manner that a backrest is conjointly moved when a seat face is adjusted are known from the prior art. However, the movement of the backrest and of the seat face can generate a relative movement in terms of an occupant. This relative movement is known as “shirt shear”, for example, describing a sliding movement of a surface, or a front face, of the backrest in relation to the occupant. In a conventional seat, there is a rotary fitting at the bottom of the backrest, and the backrest rotates backward about the rotary fitting. When the backrest rotates towards the rear, a relative movement between the surface of the backrest and the back of the occupant arises, which can lead to shearing of an item of clothing. In the case of reclining adjustment mechanisms, contact between the seat, in particular the seat face, and the thighs of an occupant can also be lost if the seat is inclined and/or the occupant reclines. Furthermore, contact between the seat, in particular the backrest and/or a headrest, and the occiput and/or shoulders of the occupant can be lost during a reclining adjustment of the seat, as a result of which the occupant is forced to assume a forward-directed head posture and/or a forward-leaning body posture when in motion in order to maintain sight of a road surface.

### OBJECT

The invention is based on the object of improving a seat, in particular a vehicle seat, of the type mentioned at the outset, in particular providing a seat which is adjustable, for example reclinable, in space and in which at least the seat face is kept in constant contact with the thighs of the occupant, and providing a seat in which the backrest is kept largely in permanent contact with the torso of the occupant when said seat inclines and/or reclines in space.

### ACHIEVEMENT

In a first exemplary embodiment, this object is achieved according to the invention by a seat, in particular vehicle seat, comprising at least one seat structure and one adjustment device having at least one pivoting mechanism for pivoting the seat structure about a pivot axis, wherein the seat structure comprises at least one seat frame and a seat shell which is pivotably mounted on the seat frame, and wherein the pivoting mechanism is coupled to the seat structure and specified to move the seat frame about the pivot axis and, as a function of a pivoting direction of the seat frame, to move the seat shell relative to the latter and in a pivoting direction counter to the pivoting direction of the seat frame.

The advantages achieved by the invention lie in that a seat, in particular a vehicle seat, having a seat frame is able to be provided, wherein the seat frame is designed to be freely tiltable, inclinable or pivotable in space and has at least one seat shell which is movable, for example tiltable, inclinable or pivotable, relative to the seat frame in such a manner that the seat shell can follow a movement of legs of a person sitting on the seat. As a result of the pivotable connection of the seat shell on the seat frame, a level of comfort, for example sitting comfort and/or lying comfort, is enhanced in ergonomic terms, and a body sitting posture and/or body lying posture is improved. The seat can be adjusted in such a manner that parts of the body of the person sitting on the seat, also referred to as an occupant, are sufficiently ergonomically supported, or remain rested.

Furthermore, the pivoting of the seat shell in a pivoting direction counter to the pivoting direction of the seat frame advantageously enables the occupant to maintain the same heel point in terms of a floor, in particular a vehicle floor, during an adjustment of the seat.

Furthermore, the pivoting of the seat shell in a pivoting direction counter to the pivoting direction of the seat frame advantageously enables the occupant to keep a larger area of the body of the occupant in constant contact with the seat structure, for example a torso of the occupant with a backrest face, and a posterior of the occupant with a seat face. The seat face and the backrest face can be part of an integrally formed seat structure. The seat structure can, for example, comprise at least one seat face structure and/or one backrest face structure, later also referred to as the backrest structure. The constant contact between the body of the occupant and the seating structure makes it possible not to experience any relative movement between the body, for example a back and the backrest face and/or between the posterior and the seat face and, optionally, additionally the backrest face, as a result of which so-called “shirt shear” is avoided, for example.

Furthermore, the pivoting of the seat shell in a pivoting direction counter to the pivoting direction of the seat frame makes it advantageously possible for the occupant that a centerline of the seat structure, in particular proceeding from a backrest face or the backrest, respectively, can change so as to support a lumbar lordosis of the occupant when the seat structure is adjusted in space, for example is pivoted, tilted or inclined. A change in a seat contour in conjunction with the pivoting of the seat shell, for example in the form of a frontal bolster, has the effect that the occupant is imparted natural support for his/her lumbar lordosis during pivoting of the seat structure.

The seat frame can be designed as an additional seat shell. In other words: the seat structure can comprise at least one seat face structure having a first seat shell, and a second seat shell which is pivotably mounted on the first seat shell, and at least one pivoting mechanism for pivoting the seat face structure about a pivot axis, or relative to a floor, in particular the vehicle floor, respectively, wherein the pivoting mechanism is specified to pivot the second seat shell in an opposite direction when the first seat shell is being pivoted.

For example, when viewed in the longitudinal direction, the second seat shell is disposed in a front shell region of the first seat shell.

As a result of the second seat shell being mounted on the first seat shell, and the second seat shell being pivoted in an opposite direction when the first seat shell is being pivoted, the seat face structure can follow a leg movement of the occupant, whereby a constant contact between the thighs of the occupant and the seat face is ensured. Pivoting, for example inclining or tilting, the second, for example the front, seat shell enables the occupant to maintain a heel point in each seat position. As a result, a level of seating comfort and a body posture of the occupant can be improved during and after adjustment of the seat.

A rear region of the seat shell can have a fulcrum which is mounted on a seat frame, wherein pivoting the seat shell about the fulcrum causes a variation in the spacing of a front region of the seat shell relative to the seat frame.

The fulcrum of the seat shell can be disposed at least in the region of the pivot axis of the seat frame. For example, a rotation axis of the seat shell, which is defined by the fulcrum, can extend so as to be offset, or spaced apart, from the pivot axis of the seat frame so as to be parallel thereto. Alternatively, the rotation axis and the pivot axis can be disposed so as to overlap one another.

The pivoting mechanism can be designed in such a manner that the pivoting mechanism moves the seat frame about an imaginary pivot axis extending transversely to the pivoting direction of the seat frame. An imaginary pivot axis can be understood to mean, for example, a fictitious, virtual pivot axis. As a result of the pivoting mechanism, the seat frame can be pivoted largely independently of coupling points between the pivoting mechanism and the seat frame. This can offer the advantage that the seat structure can be designed to be freely pivotable in space, enabling an ergonomic motion sequence which enhances the level of comfort. The pivot axis can be aligned in such a manner that a hip joint, or a position of the hip joint, respectively, is always kept above the pivot axis, and optionally additionally on a common imaginary line. Advantages of the invention can lie in that an integral seat is provided, and a conventional fitting between the seat face and the backrest is dispensed with. The seat can in particular be designed with a reduced weight and a reduction in parts. The entire seat can be pivoted in space, whereby an upper body angle of up to 45° can be achieved by the rotatably mounted seat shell and the latter's dependent pivoting relative to the seat frame. The seat shell can rotate downward or upward about the fulcrum simultaneously with the pivoting movement of the seat frame in space. It can be ensured as a result that the lower extremities, for example the legs of the occupant, are conjointly pivoted about the anatomic hip joint in an ergonomically advantageous manner. In the process, an angle between the thigh and the torso can be ergonomically increased or decreased, as a result of which a neutral posture is achieved, and a lumbar spine can be relieved, for example.

The seat shell can be a leg rest. The seat shell can be designed as an upholstery shell or as a cushion shell. The seat shell can rotate about a rotation axis directly below the anatomic hip joint and/or the anatomic rotation axis of the latter, and/or somewhat before or behind a position of ischial tuberosities of the occupant. For example, the rotation axis, or the fulcrum, of the seat shell can extend largely through a center, or in the region of a center, of a hip rotation.

The pivoting mechanism can comprise at least one front linkage and at least one rear linkage which connect in each case the seat frame to a fixed base frame, wherein the front linkage or the rear linkage has at least two linkage arms, for example also referred to as swing arms or lever arms, which are adjustable relative to one another at an angle in order to pivot the seat frame.

Furthermore, at least one first drive unit which during operation is specified to pivot the seat frame can be provided, wherein the first drive unit has at least one connecting point fixed to the seat frame, in particular positionally fixed, and a connecting point which is connected to the pivoting mechanism and rotatably mounted. The drive unit by way of its fixed connecting point can be fastened to a crossbar of the seat frame. The drive unit by way of its rotatably mounted connecting point can be connected with one of the linkage arms of the rear linkage or of the front linkage.

Furthermore, at least one second drive unit which during operation is specified to pivot the seat shell relative to the seat frame can be provided, wherein the drive unit has at least one connecting point fixed to the seat shell, in particular positionally fixed, and a connecting point which is rotatably mounted on the seat frame, or vice versa. The drive unit by way of its connecting point can be rotatably mounted on the crossbar of the seat frame. The drive unit by way of its fixed connecting point can be fastened to a lower side, for example to a bracket disposed on the lower side, or a holding arm of the seat shell.

Furthermore, at least one third drive unit which is specified to adjust the seat frame in terms of its height relative to a base frame can be provided, wherein the third drive unit has at least one, in particular positionally fixed, connecting point fixed to a base frame, and a rotatably mounted connecting point which is connected to the pivoting mechanism. The drive unit by way of its fixed connecting point can be fastened to a base frame. The drive unit by way of its rotatably mounted connecting point can be connected to one of the linkages.

The drive units, in particular at least the first drive unit and the second drive unit, can be able to be synchronously operated. For example, an adjustment movement of the drive units can be synchronized. For example, a synchronizing device and/or a suitable control unit can be provided, which can in each case be connected to the drive units for signaling. In a synchronized state of the drive units, i.e. at least of the first and the second drive unit, adjustment movements of drive motors of the drive units can be synchronized. The third drive unit can be operated independently and/or so as to be synchronized with the two other drive units. It is also possible that the second drive unit can be able to be operated independently of the first drive unit in an adjusted seat position.

The adjustment device can comprise at least one height adjustment mechanism, which is connected to the pivoting mechanism, and/or a longitudinal adjustment apparatus.

In a second exemplary embodiment, the object is achieved according to the invention by a seat, comprising at least one seat structure, for example a backrest structure, having a first back shell, for example a backrest frame, and a second back shell, for example an upholstery shell and/or a backrest support shell, which is pivotably mounted on the first back shell, and at least one pivoting mechanism for pivoting the seat structure, in particular the backrest structure, about a pivot axis, wherein the pivoting mechanism is coupled to the backrest structure and is specified to pivot the second back shell relative to a frontal plane of the first back shell, and/or to move the first back shell about the pivot axis and, as a function of a pivoting direction of the first back shell, move the second back shell relative to the latter and in a pivoting direction counter to the pivoting direction of the first back shell. A lower region of the second back shell can have a fulcrum which is mounted on the first back shell, in particular on the backrest frame, wherein pivoting of the second back shell about the fulcrum causes a variation in the spacing of an upper region of the second back shell relative to the first back shell.

A headrest structure which is coupled to the backrest structure can optionally be additionally provided. For example, the headrest structure can be connected to the second back shell and be pivotably mounted on the first back shell. An upper region of the second back shell can be provided with a headrest structure. For example, the headrest structure can be fixedly connected to the upper region of the second back shell. An upper region of the second back shell can be provided with at least one headrest upholstery. Alternatively or optionally additionally, the headrest structure and the second back shell can be integrally formed. The pivoting mechanism can be specified to pivot the second back shell and the headrest structure relative to a frontal plane of the first back shell.

At least one drive unit which in operation is specified to pivot the second back shell relative to the first back shell can be provided, wherein the first drive unit has at least one in particular positionally fixed connecting point which is fixed to the second back shell, and a rotatably mounted connecting point which is connected to the first back shell.

For example, when viewed in the vertical direction, the second back shell is disposed in an upper shell region of the first back shell.

As a result of the second back shell being pivotable relative to a frontal plane of the first back shell, the seat face structure can follow a leg movement of an occupant sitting on the seat. This constant contact with the backrest can make it possible for the occupant not to experience a relative movement between his/her back and the backrest, as a result of which the sliding movement (shirt shear) between the seat and the occupant is avoided.

A seat, in particular a vehicle seat, in which a centerline of the back rest varies in such a manner that a lumbar lordosis of the occupant can be supported when said seat is inclined and/or reclined in space, can provide a combination of the features of the above-mentioned exemplary embodiments. A movement contour generated by the adjustable back shells, in combination with the incline of the seat shells, in particular of the second seat shell, in particular in the form of a frontal bolster, has the advantage that the occupant experiences a natural support of his/her lumbar lordosis and of his/her thighs during and after adjustment of the seat.

In summary, and in other words, the invention provides a seat, in particular a vehicle seat, in which a position of the heel point relative to the vehicle floor, a head position and a shoulder position with a view of the road surface, and a suitable chest posture, or upper body posture, can be maintained in each seat position of the seat. Also, any unintentional kyphosis can be reduced. Furthermore, a suitable hip angle with a neutral back posture can be assumed as a result of the seat according to the invention. In the event of an accident, the seat enables a so-called pre-crash position to be rapidly assumed, for example by a small adjustment travel and/or rail travel.

### FIGURES AND EMBODIMENTS OF THE INVENTION

The invention is described in more detail below by advantageous exemplary embodiments illustrated in the figures. However, the invention is not limited to these exemplary embodiments. In the figures:

FIG. 1 shows a vehicle seat having a longitudinal adjustment apparatus according to the prior art, in a schematic illustration;

FIG. 2 shows a lateral view of a seat according to the invention, in particular a vehicle seat, according to a first exemplary embodiment, wherein the seat comprises at least one seat face structure and a backrest structure, and is in a first seat position;

FIG. 3 shows a lateral view of the seat according to FIG. 2 in a second seat position;

FIG. 4 shows a lateral view of the seat according to FIG. 2, having a headrest structure, wherein the seat is in the first seat position;

FIG. 5 shows a lateral view of the seat according to FIG. 4 in the second seat position;

FIG. 6 shows a lateral view of the seat according to FIG. 4 in a third seat position;

FIG. 7 shows a lateral view of the seat according to FIG. 4 in a fourth seat position;

FIG. 8 shows a perspective view of a seat face structure of a seat, in particular a vehicle seat, having a pivoting mechanism for pivoting the seat face structure;

FIG. 9 shows a perspective view of the seat face structure according to FIG. 8;

FIG. 10 shows a perspective lower view of the seat face structure according to FIG. 8;

FIG. 11 shows an exploded illustration of the seat face structure according to FIG. 8;

FIG. 12 shows a lateral view of a seat, in particular a vehicle seat, according to a second exemplary embodiment, wherein the seat comprises at least one seat face structure, a backrest structure and a headrest structure and is in a first seat position;

FIG. 13 shows a lateral view of the seat according to FIG. 12 in an intermediate position;

FIG. 14 shows a lateral view of the seat according to FIG. 12 in a second seat position;

FIG. 15 shows a lateral view of the seat according to FIG. 12 in a comfort position;

FIG. 16 shows a lateral view of the seat according to FIG. 12 in the first seat position;

FIG. 17 shows a perspective rear view of a backrest structure and of a headrest structure fastened to the backrest structure;

FIG. 18 shows a perspective rear view of the backrest structure and of the headrest structure according to FIG. 17 in a first backrest position; and

FIG. 19 shows a perspective rear view of the backrest structure and of the headrest structure according to FIG. 17 in a second backrest position.

Equivalent parts are provided with the same reference signs in all figures.

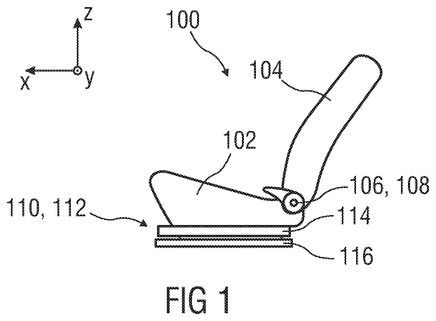

A vehicle seat 100 pertaining to the prior art, which is schematically illustrated in FIG. 1, will be described hereunder while using three spatial directions extending perpendicularly to one another. In the case of a vehicle seat 100 installed in the vehicle, a longitudinal direction x extends largely horizontally and preferably parallel to a vehicle longitudinal direction, the latter corresponding to the usual direction of travel of the vehicle. A transverse direction y, extending perpendicularly to the longitudinal direction x, is likewise horizontally aligned in the vehicle and extends parallel to a vehicle transverse direction. A vertical direction z extends perpendicularly to the longitudinal direction x and perpendicularly to the transverse direction y. In the case of a vehicle seat 100 installed in the vehicle, the vertical direction z preferably extends parallel to a vehicle vertical axis.

The positional and directional indications used, such as front, rear, top and bottom, relate to a viewing direction of an occupant I seated in the vehicle seat 100 in a normal seating position, the vehicle seat 100 being installed in the vehicle, in a use position which is suitable for passenger transportation, with an upright backrest 104, and is oriented, as is customary, in the direction of travel. The vehicle seat 100 may also be installed or moved, however, in a different orientation, for example transversely to the direction of travel. Unless otherwise described the vehicle seat 100 is constructed so as to be mirror-symmetrical in terms of a plane extending perpendicularly to the transverse direction y.

The backrest 104 can be pivotably disposed on a seat part 102 of the vehicle seat 100. For this purpose, the vehicle seat 100 can optionally comprise a fitting 106, in particular an adjustment fitting, a rotary fitting, a latching fitting or a tumbling fitting.

The positional and directional indications used, such as radial, axial and in the circumferential direction, for example, relate to a rotation axis 108 of the fitting 106. Radial means perpendicular to the rotation axis 108. Axial means in the direction of the rotation axis 108, or parallel thereto.

The vehicle seat 100 can optionally comprise a longitudinal adjustment apparatus 110. The longitudinal adjustment apparatus 110 comprises, for example, a rail assembly 112 having a first rail element 114 and a second rail element 116. The first rail element 114 is adjustable in the longitudinal direction x relative to the second rail element 116. The first rail element 114 is fastened to the seat part 102. The first rail element 114 is, for example, an upper rail or runner rail. The second rail element 116 is fastened to a structural element of a vehicle, for example to a vehicle floor. The second rail element 116 is, for example, a lower rail or floor rail.

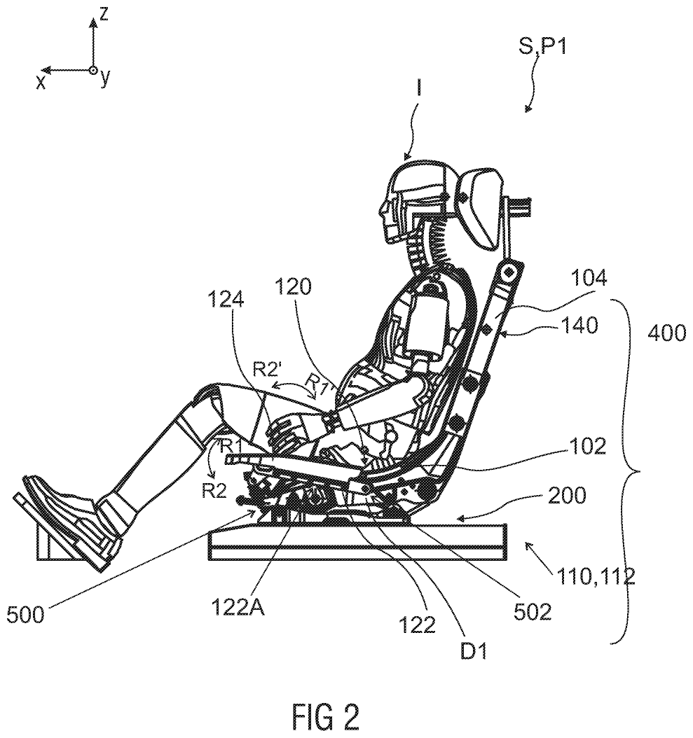

FIG. 2 shows a lateral view of a seat S according to the invention, in particular a vehicle seat 100, according to a first exemplary embodiment, wherein the seat S comprises a seat structure 400 which is formed from frame parts, for example. The seat S, in particular the seat structure 400, comprises at least one seat face structure 120 for forming the seat part 102, and a backrest structure 140 for forming the backrest 104, and is in a first seat position P1. The first seat position P1 can be a driving position and/or initial position. The seat S can be adjusted between a plurality of seat positions, comfort positions and/or intermediate positions.

The seat face structure 120 comprises a first seat shell 122. The first seat shell 122 can form, for example, a main body or base body of the seat part 102. In the exemplary embodiment illustrated, the first seat shell 122 forms a seat frame 122A. Furthermore, the seat face structure 120 comprises a second seat shell 124 which is pivotably mounted on the first seat shell 122. The second seat shell 124 can be a frontal shell which can be disposed in the front shell region of the first seat shell 122. The second seat shell 124 can be designed to be shorter than the first seat shell 122. The second seat shell 124 can be half the length of the overall length of the first seat shell 122. The second seat shell 124 can be provided for supporting thighs of an occupant I. The second seat shell 124 can be disposed in a front half of the first seat shell 122 and be pivotably mounted on the latter.

The seat S comprises an adjustment device 500 having at least one pivoting mechanism 200 for pivoting the seat structure 400 about a pivot axis 502. The pivoting mechanism 200 is designed in such a manner that the pivoting mechanism 200 moves the seat frame 122A about an imaginary pivot axis 502 which extends transversely to the pivoting direction R1′, R2′, hereunder also referred to as direction R1′, R2′, of the seat frame 122A.

For example, the seat structure 400, for example the seat face structure 120, comprises a first pivoting mechanism 200 for pivoting the seat face structure 120, wherein the pivoting mechanism 200 is specified to pivot the second seat shell 124 in an opposite direction R1, R2, in particular pivoting direction R1, R2, when the first seat shell 122 is being pivoted in a direction R1′, R2′. The first seat shell 122 can be pivoted about a fulcrum D1 in a first direction R1′ and in a second direction R2′. When the seat shell 122 is pivoted in the first direction R1′, the second seat shell 124 is pivoted in a direction R2 counter to the first direction R1′. The fulcrum D1 is in particular an imaginary, fictive or virtual fulcrum D1. When the seat shell 122 is pivoted in the second direction R2′, the second sheet shell 124 is pivoted in a direction R1 counter to the second direction R2′. The seat shells 122, 124 can be upholstery shells or cushion shells.

The seat face structure 120 and the backrest structure 140 can be integrally formed. For example, the first seat shell 122 can be formed integrally with the backrest structure 140. The first seat shell 122 and the backrest structure 140 can form a common seat and backrest face.

In the proposed invention, this is a vehicle seat 100 which by way of a combination of vertical adjustment and longitudinal adjustment is able to be adapted to all sizes of people for actively driving the vehicle. The vehicle seat 100 does not have to be designed in a conventional way, having a fitting 106 which connects a seat part 102 to a backrest 104. The entire vehicle seat 100 according to the invention can be adjusted in space, for example be inclined or tilted, so as to achieve an upper body angle of up to 45°. Simultaneously with a rotating movement, in particular a tilting movement, of the first seat shell 122 in space, the second seat shell 124 rotates downward about a fulcrum D1 which enables the lower extremities to pivot about the anatomic hip joints. As a result, an angle between the thigh and the torso (for example to a maximum of 135°) can be increased, as a result of which a neutral posture is achieved and the lumbar spine can be relieved.

The first seat shell 122 can rotate about an imaginary rotation axis, in particular pivot axis 502, which is defined by the fulcrum D1 and is directly below the anatomic rotation axis or the hip joints, and somewhat in front of the ischial tuberosities. Ideally, this rotation axis should extend exactly through the center of the hip rotation.

During the rotating movement, a relative movement between the upper body of the occupant I and the backrest 104, or between the occiput of the occupant I and a headrest 118 illustrated in the additional figures, is thus largely reduced or even avoided.

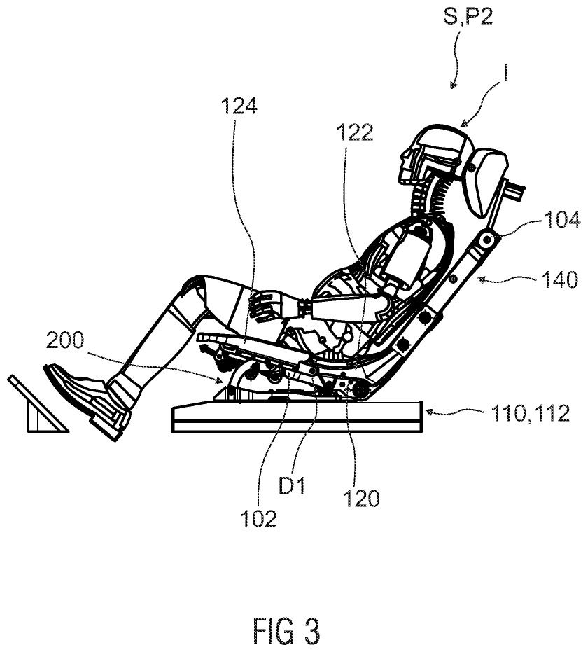

FIG. 3 shows a lateral view of the seat S according to FIG. 2 in a second seat position P2. The second seat position P2 can be, for example, a rearwardly inclined or tilted comfort position.

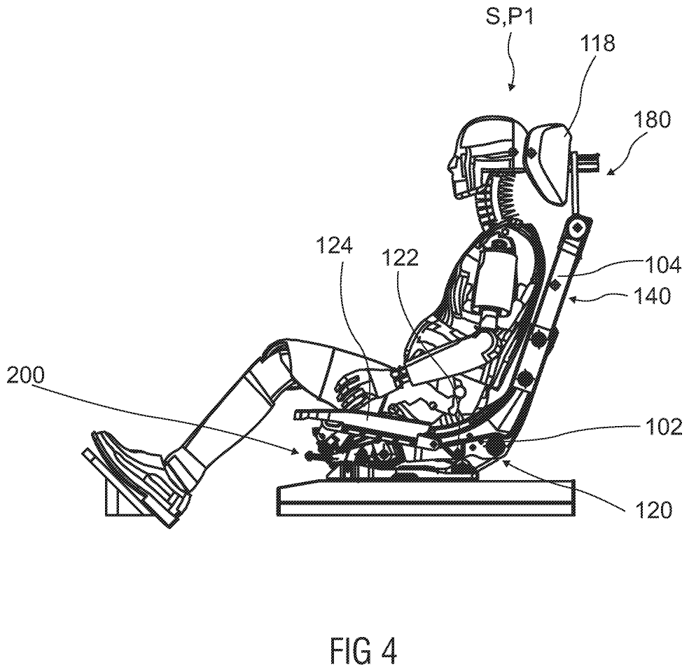

FIG. 4 shows a lateral view of the seat S having a headrest structure 180 for forming and mounting the headrest 118 on the backrest structure 140. The seat S is in the first seat position P1. The headrest structure 180 is disposed on an upper side of the backrest structure 140.

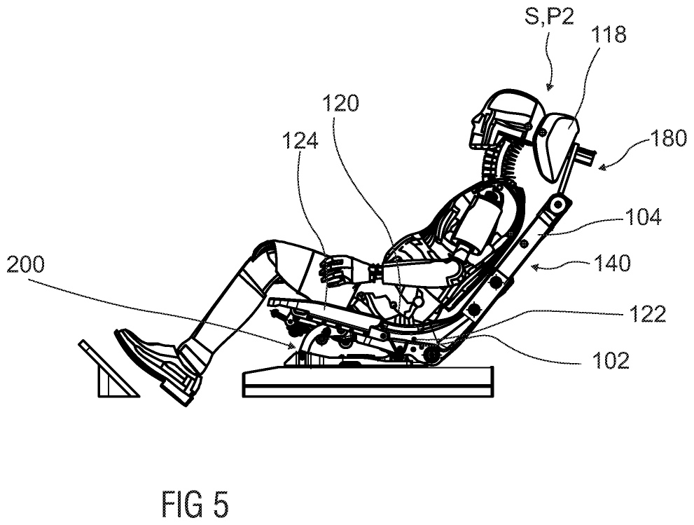

FIG. 5 shows a lateral view of the seat S according to FIG. 4 in the second seat position P2.

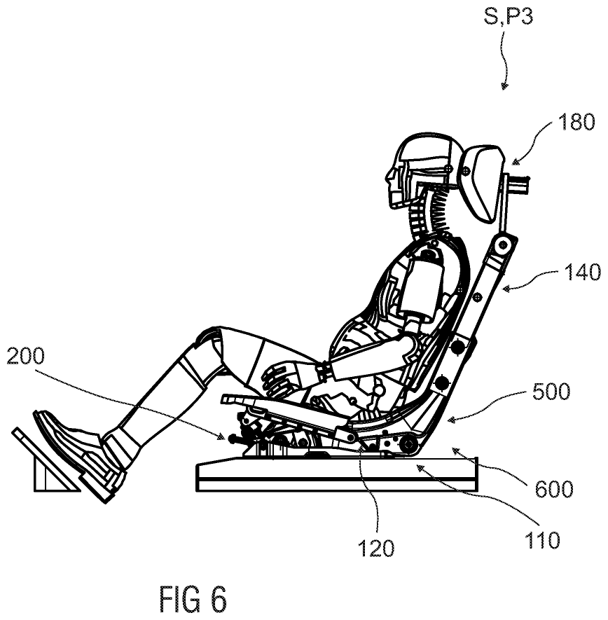

FIG. 6 shows a lateral view of the seat S in a third seat position P3. In the third seat position P3, the seat S can be adjusted downward in the vertical direction z, in particular adjusted for height. The adjustment device 500 can comprise a height adjustment mechanism 600 which is connected to the pivoting mechanism 200. The adjustment device 500 can furthermore comprise a longitudinal adjustment mechanism, in particular a longitudinal adjustment apparatus 110. For example, the pivoting mechanism 200 can be designed to move the seat S about the fulcrum D1 as well is in the vertical direction z. The pivoting mechanism 200 can be a combined inclination and height adjuster.

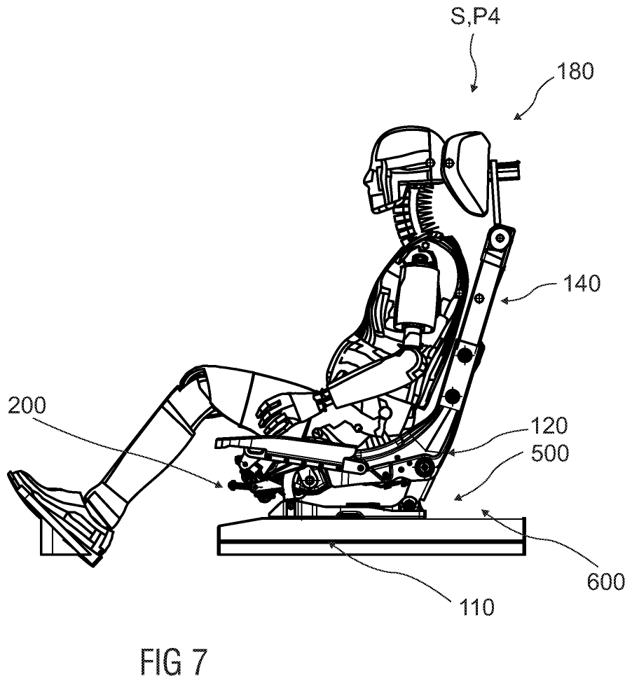

FIG. 7 shows a lateral view of the seat S according to FIG. 6 in a fourth seat position P4. In the fourth seat position P4, the seat S can be adjusted upward in the vertical direction z, in particular adjusted for height.

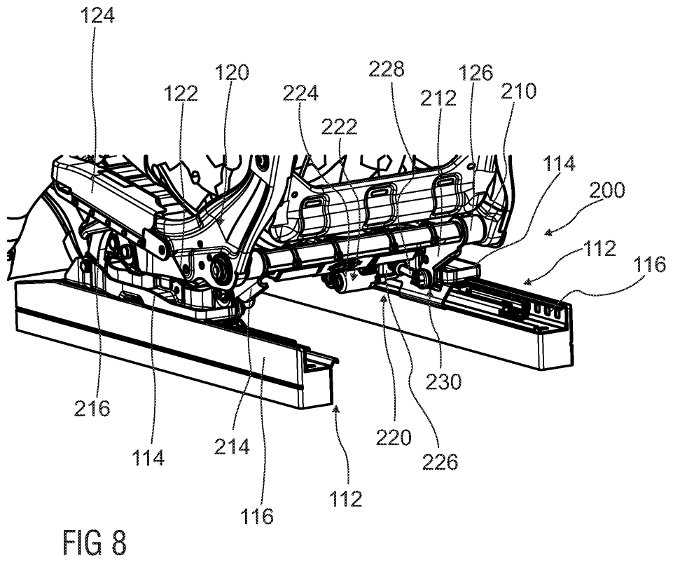

FIG. 8 shows a perspective view of a seat face structure 120 of a seat S, in particular vehicle seat 100, having a pivoting mechanism 200 for pivoting the seat face structure 120. The pivoting mechanism 200 can be designed as inclination and height adjustment kinematics. The pivoting mechanism 200 can be operatively connected to the longitudinal adjustment apparatus 110. For example, the pivoting mechanism 200 can be coupled to in each case one rail assembly 112 on both sides of the seat. Pivoting of the seat S can cause a longitudinal adjustment of the seat S, or vice versa.

The pivoting mechanism 200 comprises on each of two sides of the seat of the seat face structure 120, which are disposed so as to be mutually offset in a transverse direction y, in each case one joint assembly 210, for example a quadruple joint assembly or a multi-joint assembly, and drive kinematics 220 which consists of several or a plurality of drive units 222, for example.

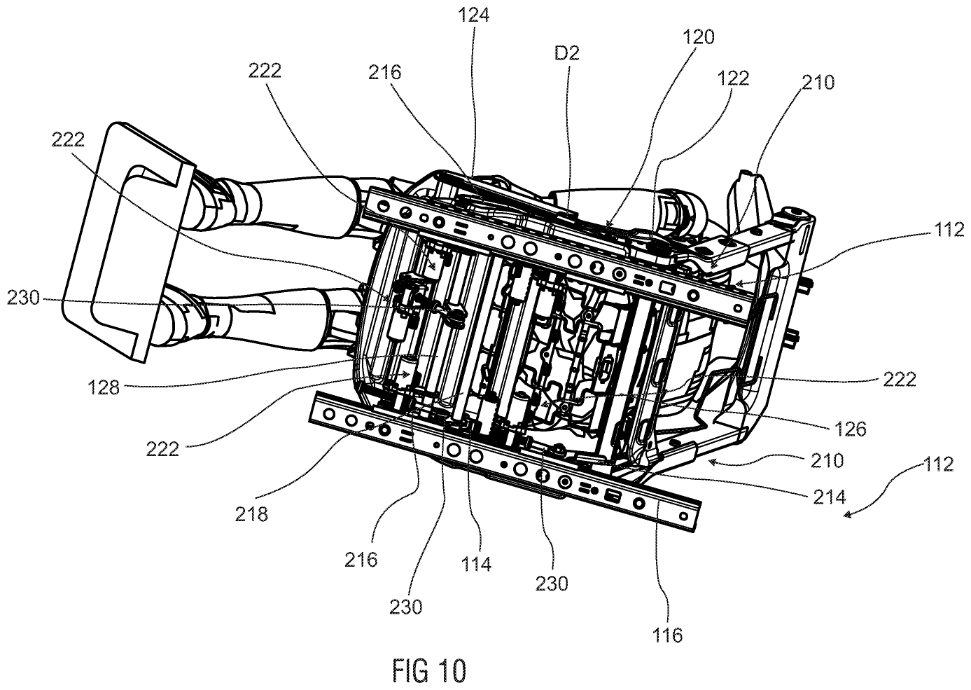

The drive kinematics 220 is connected to the respective joint assembly 210 by way of coupling interfaces 230, as can be better seen in FIG. 10.

The joint assembly 210 is connected to the first rail element 114 of the rail assembly 112, for example. The drive kinematics 220 is likewise fastened to the first rail element 114 and operatively connected to the joint assembly 210 by way of the first rail element 114. An adjustment of the seat face structure 120 is caused by a movement of the joint assembly 210, or joint assemblies 210, respectively, relative to the first rail elements 114 by the drive kinematics 220.

The drive units 222 can be spindle drives. The drive units 222 can comprise in each case one motor 221, one gear unit 226 which is connected to the motor 224, and one spindle 228 which is adjustable relative to the gear unit 226.

For example, at least one drive unit 222 can be fastened to the first rail element 114 and be connected to at least one adjustment arm 212 of the joint assembly 210. The adjustment arm 212 is connected to the first seat shell 122 and to the first rail element 114. For example, the adjustment arm 212 can be fastened to a crossbar 126 which connects the seat sides. The adjustment arm 212 can be connected to a seat side of the first seat shell 122. The adjustment arm 212 is rotatably mounted on the first rail element 114.

The adjustment arm 212 can be designed as a rear linkage 214 of the joint assembly 210. Furthermore, the joint assembly 210 can have at least one front linkage 216. The front linkage 216 is connected to the seat side of the first seat shell 122. The front linkages 216 of the joint assemblies 210 can be connected to one another by way of a connecting web 218 (illustrated in FIG. 10), for example in the form of a bar.

At least one drive unit 222, which initiates a movement of the front linkages 216, can be fastened to a front crossbar 128 which connects the seat sides of the first seat shell 122 to one another. The drive unit 222 is rotatably mounted on the front linkage 216 of at least one of the joint assemblies 210 by way of a coupling interface 230.

An adjustment of the seat face structure 120 is caused by a movement of the front linkages 216 relative to the fixed crossbar 128 by the drive kinematics 220.

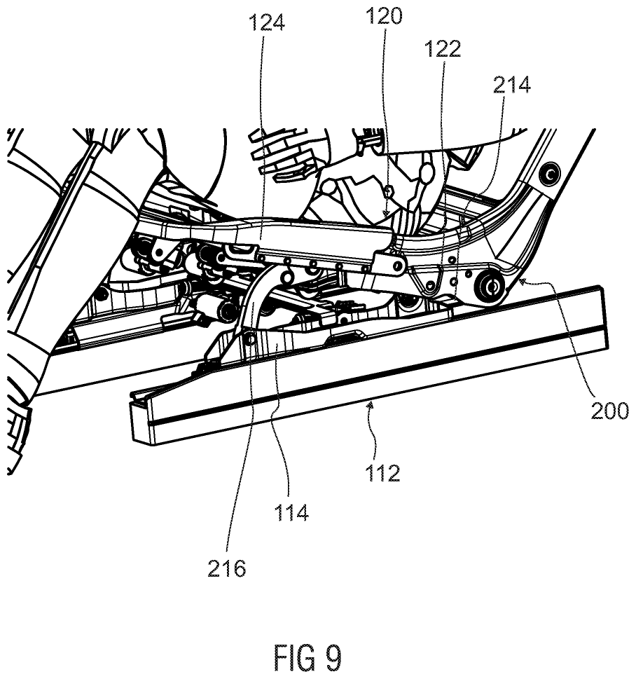

FIG. 9 shows a perspective view of the seat face structure 120, and FIG. 10 shows a perspective lower view of the seat face structure 120.

For pivoting the second seat shell 124 relative to the first seat shell 122, a rear end of the second seat shell 124 is pivotably articulated on the first seat shell 122. A front end of the second seat shell 124 is connected to the front crossbar 128 by way of the drive kinematics 220, in particular by way of at least one drive unit 222 of the drive kinematics 220. The second seat shell 124 can be pivoted relative to the first seat shell 122 about a fulcrum D2 by a spindle movement of the drive unit 222.

The drive kinematics 220 can be specified in such a manner, for example, that a movement of the joint assembly 210 and a movement of the second seat shell 124 are performed so as to be mutually synchronized.

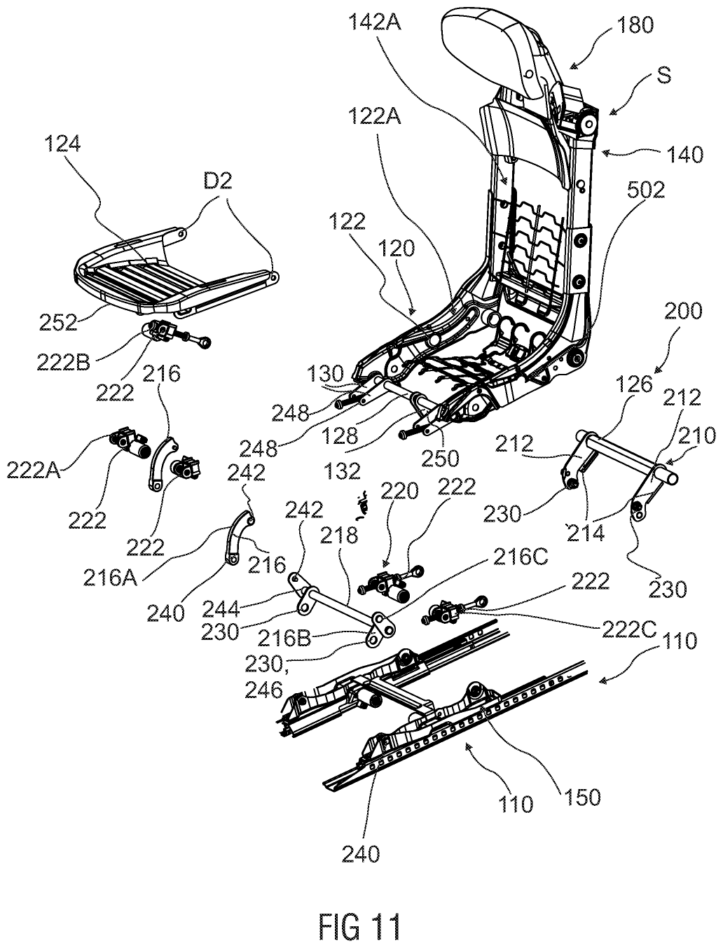

FIG. 11 shows an exploded illustration of the seat S. The seat structure 400 comprises an adjustment device 500 having a pivoting mechanism 200 for pivoting the seat structure 400 about a pivot axis 502. The seat structure 400 comprises a seat frame 122A and a backrest frame 142A. The seat frame 122A and the backrest frame 142A can be integrally formed and be conjointly adjustable, in particular pivotable. Furthermore, the seat structure 400 comprises at least one seat shell 124 which is pivotably mounted on the seat frame 122A. The pivoting mechanism 200 is coupled to the seat structure 400 and is specified to move the seat frame 122A about the pivot axis 502 and, as a function of a pivoting direction R1′, R2′ of the seat frame 122A, move the seat shell 124 relative to the latter and in a pivoting direction R1, R2 counter to the pivoting direction R1′, R2′ of the seat frame 122A. A rear region of the seat shell 124 has a fulcrum D2 mounted on the seat frame 122A, wherein pivoting the seat shell 124 about the fulcrum D2 causes a variation in the spacing of a front region of the seat shell 124 relative to the seat frame 122A. The fulcrum D2 of the seat shell 124 is disposed at least in the region of the pivot axis 502 of the seat frame 122A. The pivoting mechanism 200 is designed in such a manner that the pivoting mechanism 200 moves the seat frame 122A about an imaginary pivot axis 502 extending transversely to the pivoting direction R1′, R2′ of the seat frame 122A. The pivoting mechanism 200 comprises at least one front pair of linkages having two front linkages 216, wherein one linkage 216 is in each case assigned to one seat side. The pivoting mechanism 200 comprises at least one rear pair of linkages of two rear linkages 214, wherein each seat side is assigned one linkage 214. The pairs of linkages connect in each case the seat frame 122A to a fixed base frame 150, wherein the base frame 150 is able to be connected directly to a vehicle floor, or is able to be connected to the longitudinal adjustment apparatus 110. The base frame 150 can be connected, for example, to the first rail element 114, in particular to the upper rail or runner rail. In the exemplary embodiment illustrated, the front linkages 116 comprise three linkage arms 216A to 216C which are adjustable relative to one another at an angle in order to pivot the seat frame 122A in relation to the base frame 150. The first linkage arm 216A is a support arm or a base arm, wherein the first linkage arm 216A holds, or supports, the seat frame 122A so as to be pivotable on the base frame 150. The first linkage arm 216A has a lower connecting point 240 which is fixed to the base, and a connecting point 242 which is connected to the second linkage arm 216B. The second linkage arm 216B is rotatably mounted on the first linkage arm 216A. The second linkage arm 216B is connected to the seat frame 122A by way of a connecting point 244 which is fixed to the seat frame. The second linkage arm 216B is connected to the third linkage arm 216C by way of the connecting point 244 fixed to the seat frame. For example, the second linkage arm 216B and the third linkage arm 216C can be integrally formed. For example, a linkage arm integrally formed of 216B and 216C can be designed to be substantially L-shaped. In the exemplary embodiment illustrated, the connecting web 218 extends through the connecting point 244 fixed to the seat frame, and connects the second linkage arm 216B to the third linkage arm 216C. The second linkage arm 216B and the third linkage arm 216C are firmly fixed to the connecting web 218. The second linkage arm 216B and the third linkage arm 216C are conjointly pivotable relative to the first linkage arm 216A, for example adjustable at an angle relative to the first linkage arm 216A. A front region of the seat frame 122A can be moved, in particular pivoted, about the pivot axis 502, relative to the first linkage arm 216A. The rear linkages 214 can be designed to pivotably hold the seat frame 122A. At least one of the front linkages 116 is coupled to a first drive unit 222, 222A. For example, the first drive unit 222A is connected to the third linkage arm 216C by way of the coupling interface 230. The coupling interface 230 forms a connecting point 246 by way of which the drive unit 222A is rotatably mounted on the linkage 116 of the linkage mechanism 200. Another end of the first drive unit 222A is fixed to the seat frame 122A. For this purpose, the first drive unit 222A has a connecting point 248 fixed to the seat frame 122A. For example, the connecting point 246 is provided on the crossbar 128 of the seat frame 122A. The crossbar 128 can have fixed holding arms 130 for fastening the first drive unit 222A to the seat frame 122A. At least one second drive unit 222, 222B which in operation is specified to pivot the seat shell 124 relative to the seat frame 122A is provided. The second drive unit 222B has a connecting point 250 which is rotatably mounted on the seat frame 122A, and a connecting point 252 which is fixed to the seat shell 124. The connecting point 250 is provided on the crossbar 128. The crossbar 128 can have at least one additional holding arm 132 for rotatably mounting the second drive unit 222B on the seat frame 122A. At least one third drive unit 222, 222C which is coupled to at least one of the rear linkages 214 can be provided. The rear linkage 214, or the rear linkages 214, respectively, is/are rotatably mounted on the base frame 150. During operation of the third drive unit 222C, the rear linkages 214 can be pivoted relative to the base frame 150 so as to adjust the seat S in terms of height.

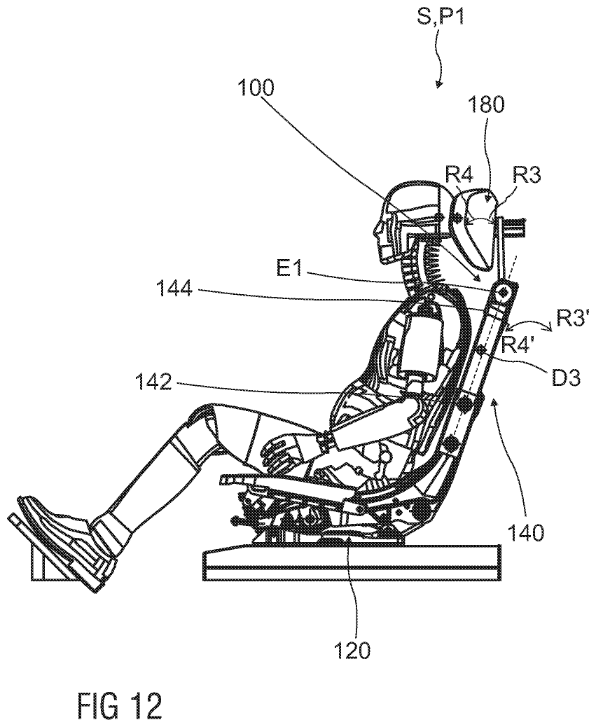

FIG. 12 shows a lateral view of a seat S, in particular a vehicle seat 100, according to a second exemplary embodiment, wherein the seat S comprises at least one seat face structure 120, one backrest structure 140 and a headrest structure 180 and is in a first seat position P1.

The backrest structure 140 comprises a first back shell 142, in particular a backrest frame 142A. The first back shell 142 can form, for example, a main body or base body of the backrest 104. Furthermore, the backrest structure 140 comprises a second back shell 144, for example an additional back support shell, which is pivotably mounted on the first back shell 142. The second back shell 144 can be a shoulder support shell which can be disposed in the upper shell region of the first back shell 142. The second back shell 144 can be designed to be shorter than the first back shell 142. The second back shell 144 can be half the length of the overall length of the first back shell 142. The second back shell 144 can be provided for supporting shoulders and/or a head of the occupant I. The second back shell 144 can be disposed in an upper half of the first back shell 144 and be pivotably mounted on the latter.

Furthermore, the seat S comprises a second pivoting mechanism 300 for pivoting the backrest structure 140, wherein the pivoting mechanism 300 is specified to pivot the second back shell 144 relative to a frontal plane E1 of the first back shell 142.

Optionally additionally, a headrest structure 180 which is coupled to the backrest structure 140 can be provided. For example, the headrest structure 180 can be connected to the second back shell 144 and be pivotably mounted on the first back shell 142. The pivoting mechanism 300 can be specified to pivot the second back shell 144 and the headrest structure 180 relative to the frontal plane E1 of the first back shell 142.

The second back shell 144 and optionally additionally the headrest structure 180 are pivotable about a fulcrum D3. The second back shell 144 and optionally additionally the headrest structure 180 are pivotable in two directions R3, R4, identified by arrows, about the fulcrum D3. The pivoting mechanism 300 can be adjusted in such a manner that the second back shell 144 is pivoted in an opposite direction R3, R4 when the first back shell 142 is being pivoted. When the first back shell 142 is pivoted in a first direction R3′, the second back shell 144 is pivoted in a direction R4 counter to the first direction R3′. When the first back shell 142 is pivoted in a second direction R4′, the second back shell 144 can be pivoted in a direction R3 counter to the second direction R4′.

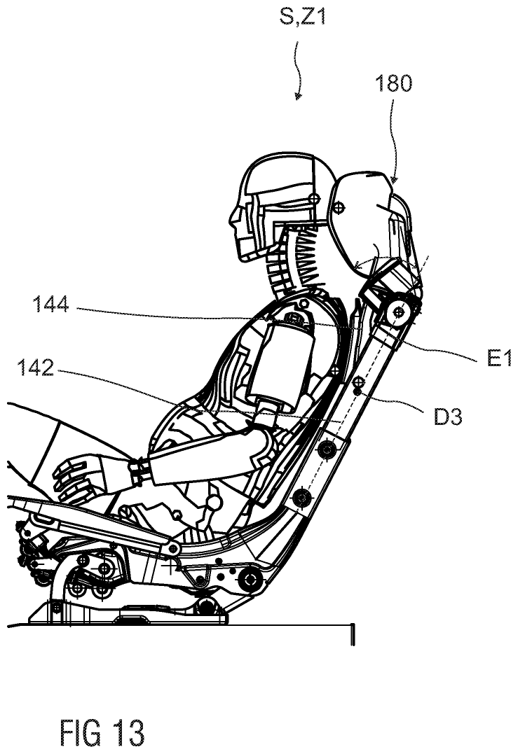

FIG. 13 shows a lateral view of the seat S according to FIG. 12 in an intermediate position Z. The first back shell 142 is adjusted toward the rear in comparison to the first seat position P1, wherein the second back shell 144 is adjusted toward the front.

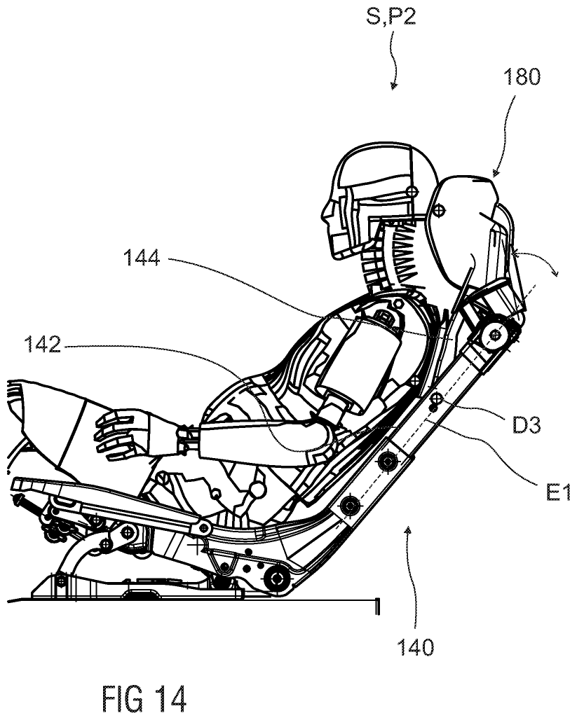

FIG. 14 shows a lateral view of the seat S according to FIG. 12 in a second seat position P2. The first back shell 142 is adjusted farther toward the back in comparison to the intermediate position Z1, wherein the second back shell 144 is adjusted farther toward the front.

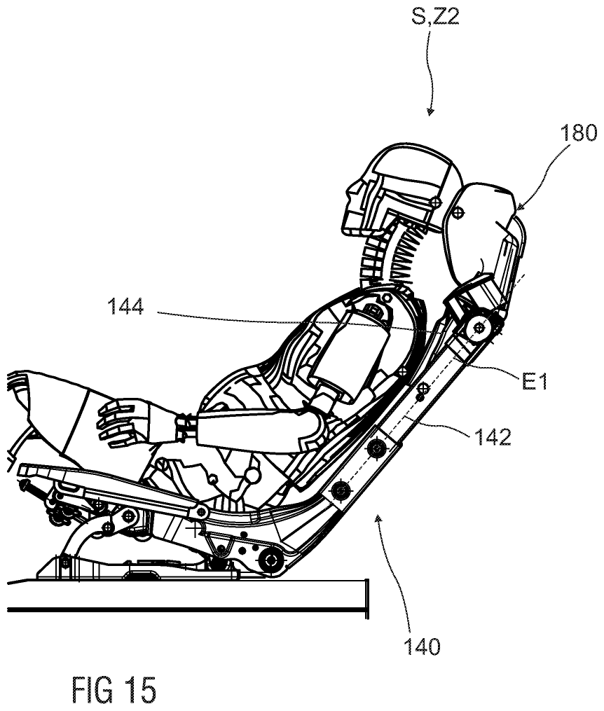

FIG. 15 shows a lateral view of the seat S according to FIG. 12 in a comfort position, in particular an additional intermediate position Z2. In this position, the first back shell 142 is in the rearmost inclined position, and the second back shell 144 is moved back in the direction of the frontal plane E1.

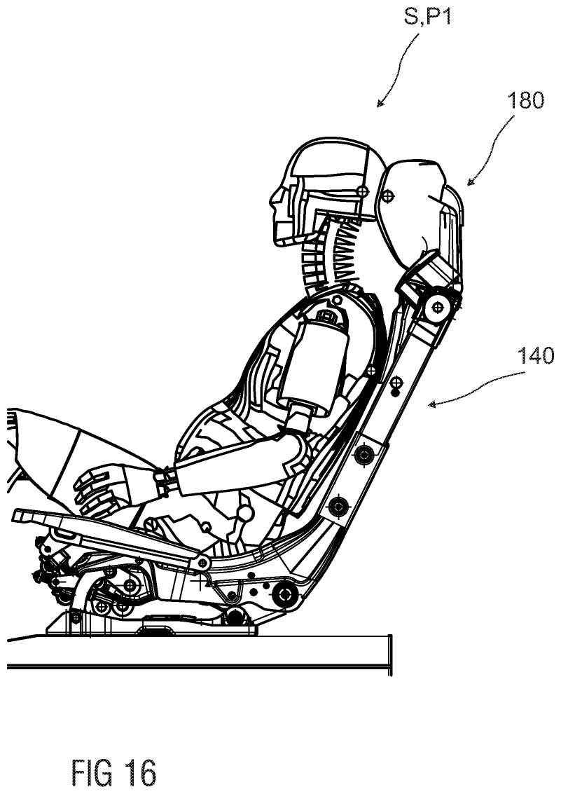

Subsequently, the seat S can be moved from the intermediate position Z2 to the first position P1 while maintaining constant contact between the occiput and the headrest structure 180 and/or between the shoulders and the backrest structure 140, as is shown in FIG. 16.

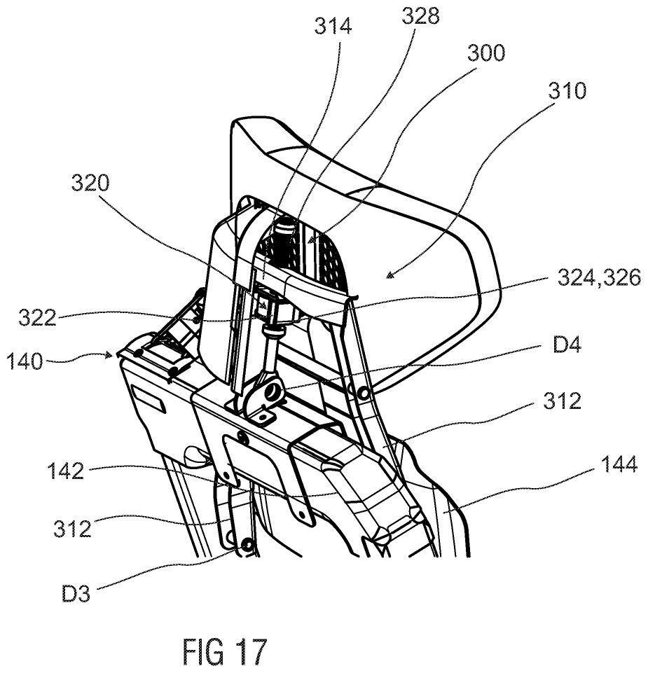

FIG. 17 shows a perspective rear view of a backrest structure 140 and of a headrest structure 180 fastened to the backrest structure 140. A pivoting mechanism 300 is furthermore provided. The pivoting mechanism 300 can comprise a joint assembly 310 and drive kinematics 320 having at least one drive unit 322.

The drive unit 322 comprises a motor 324, a gear unit 326 which is connected to the motor 324, and a spindle 328 which is adjustable relative to the gear unit 326. The drive unit 322 is mounted on the first back shell 142 so as to be pivotable, for example about a fulcrum D4.

The second back shell 144 here is pivotably mounted on the first back shell 142 by way of the fulcrum D3. The headrest structure 180 is pivotable about the fulcrum D4. The headrest structure 180 is fastened to the second back shell 144.

The second back shell 144 and the headrest structure 180 can be pivoted by moving the spindle 328 relative to the gear unit 326.

The backrest 144 can be disposed of the joint assembly 310, for example. The back shell 144 can be fastened to lateral linkages 312 of the joint assembly 310. The lateral linkages 312 can in each case be pivotably mounted on the first back shell 144. The respective lateral linkage 312 is connected to a seat side of the first back shell 142. The lateral linkages 312 are connected to one another by way of a connecting web 314. The headrest structure 180 can be connected to the second back shell 144 by way of the connecting web 314, for example.

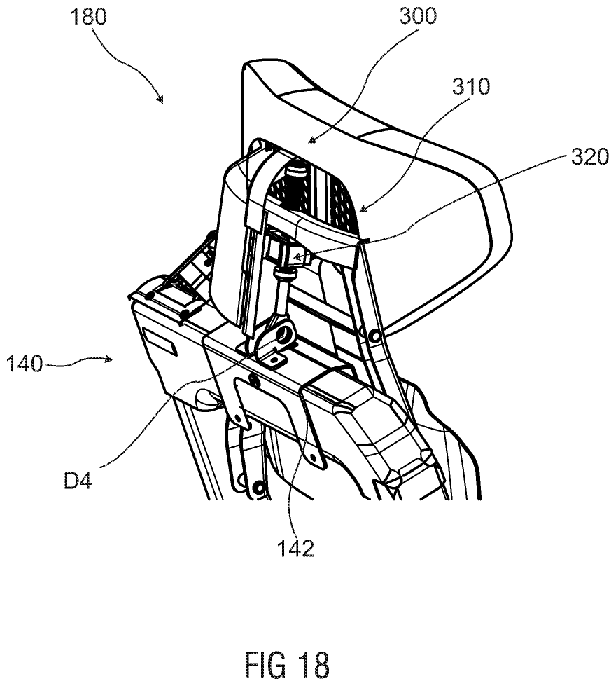

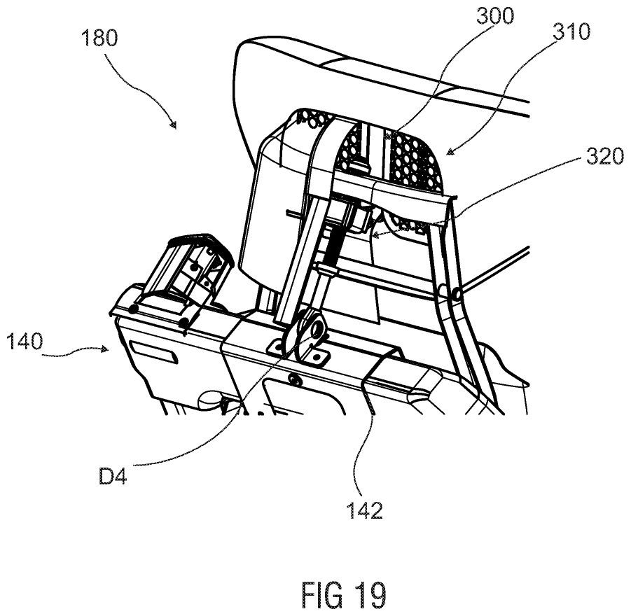

FIG. 18 shows a perspective rear view of the backrest structure 140 and of the headrest structure 180 according to FIG. 17 in a first backrest position, and FIG. 19 shows a perspective rear view of the backrest structure 140 and of the headrest structure 180 according to FIG. 17 in a second backrest position.

### LIST OF REFERENCE SIGNS

100 Vehicle seat
102 Seat part
104 Backrest
106 Fitting
108 Rotation axis
110 Longitudinal adjustment apparatus
112 Rail assembly
114 First rail element
116 Second rail element
118 Headrest
102 Seat face structure
122 First seat shell
122A Seat frame
124 Second seat shell
126 Crossbar
128 Crossbar
130 Holding arm
132 Holding arm
140 Backrest structure
142 Back shell
142A Backrest frame
144 Back shell
150 Base frame
180 Headrest structure
200 Pivoting mechanism
210 Joint assembly
213 Adjustment arm
214 Rear linkage
216 Front linkage
216A to 216C Linkage arm
218 Connecting web
220 Drive kinematics
222, 222A to 222C Drive unit
224 Motor
226 Gear unit
228 Spindle
230 Coupling interfaces
240 to 252 Connecting point
300 Pivoting mechanism
310 Joint assembly
312 Lateral linkage
314 Connecting web
320 Drive kinematics
322 Drive unit
324 Motor
326 Gear unit
328 Spindle
400 Seat structure
500 Adjustment device
502 Pivot axis
600 Height adjustment mechanism
D1 to D4 Fulcrum
E1 Frontal plane
I Occupant
P1 to P4 Seat position
R1 to R4′ Direction, particularly pivoting direction
S Seat
Z1, Z2 Intermediate position
x Longitudinal direction
y Transverse direction
z Vertical direction

1-10. (canceled)

11. A vehicle seat, comprising:
one seat structure and
one adjustment device having at least one pivoting mechanism for pivoting the seat structure about a pivot axis,
characterized in that
the seat structure comprises at least one seat frame and a seat shell which is pivotably mounted on the seat frame, wherein the pivoting mechanism is coupled to the seat structure and specified to move the seat frame about the pivot axis and, as a function of a pivoting direction of the seat frame, to move the seat shell relative to the latter and in a pivoting direction counter to the pivoting direction of the seat frame.

12. The seat as claimed in claim 11, characterized in that a rear region of the seat shell has a fulcrum mounted on the seat frame, wherein pivoting the seat shell about the fulcrum causes a variation in the spacing of a front region of the seat shell relative to the seat frame.

13. The seat as claimed in claim 12, characterized in that the fulcrum of the seat shell is disposed at least in the region of the pivot axis of the seat frame.

14. The seat as claimed in claim 11, characterized in that the pivoting mechanism is designed in such a manner that the pivoting mechanism moves the seat frame about an imaginary pivot axis extending transversely to the pivoting direction of the seat frame.

15. The seat as claimed in claim 11, characterized in that the pivoting mechanism comprises at least one front linkage and at least one rear linkage which connect in each case the seat frame to a fixed base frame, wherein the front linkage or the rear linkage has at least two linkage arms which are adjustable relative to one another at an angle in order to pivot the seat frame.

16. The seat as claimed in claim 11, characterized in that provided is at least one first drive unit which during operation is specified to pivot the seat frame, wherein the first drive unit has at least one connecting point fixed to the seat frame, and a connecting point which is connected to the pivoting mechanism and rotatably mounted.

17. The seat as claimed in claim 11, characterized in that provided is at least one second drive unit which during operation is specified to pivot the seat shell relative to the seat frame, wherein the second drive unit has at least one connecting point fixed to the seat shell, and a connecting point which is rotatably mounted on the seat frame.

18. The seat as claimed in claim 17, characterized in that the drive units are able to be synchronously operated.

19. The seat as claimed in claim 11, characterized in that the adjustment device comprises at least one height adjustment mechanism, which is connected to the pivoting mechanism, and/or a longitudinal adjustment apparatus.

20. The seat as claimed in claim 11, wherein the seat structure comprises a backrest frame which is fixedly connected to the seat frame and/or formed integrally with the latter.
